(19) United States
(12) Patent Application Publication
(10) Pub. No.: US 2002/0161601 A1
(43) Pub. Date: Oct. 31, 2002

(54) Billing method for multimedia networks

(76) Inventors: Bernhard Nauer, Muenchen (DE); Thomas Pfoertner, Hohenkirchen (DE)

Correspondence Address: BELL, BOYD & LLOYD, LLC, P. O. BOX 1135, CHICAGO, IL, 60690-1135, US

(21) Appl. No.: 10/062,151

(22) Filed: Jan. 30, 2002

(30) Foreign Application Priority Data
Jan. 30, 2001 (EP) 01102066.6

(51) Int. Cl. G06F 17/60

(52) U.S. Cl. 705/1

(57) ABSTRACT

A method of billing for the use of a, in particular multimedia communications network on the basis of the associated cost factors for a transaction performed between a number of operators and a subscriber using a respective transaction, an operator/subscriber involved in the transaction and/or a further operator/subscriber uses the respective access device to settle accounts with a number of operators/subscribers in real time using a billing data record created, transmitted and processed in the communications network.

### BACKGROUND OF THE INVENTION

The present invention relates to a method of billing for the use of a, in particular multimedia, communications network on the basis of the associated cost factors for a transaction performed between a number of operators and at least one subscriber.

Multimedia networks result from the use of integrated terminals and open transmission networks across network types and from the provision of arbitrary network access and integrated services. It is, thus, conceivable for today'telecommunication, television, radio and computer networks to be combined to form a single multimedia network.

A first approach to a multimedia network results from connecting mobile radio networks and the Internet. This makes it possible to use Internet services, Internet applications and contents in the mobile radio network. To guarantee efficient use, second generation mobile radio networks are increasingly being retrofitted with novel technologies, such as WAP (Wide Area Paging), GPRS (General Pocket Radio Service) and EDGE (Enhanced Data Rates for Global Evolution). Third generation mobile radio networks (IMT-2000 Technology) already include the opportunity for efficient use of Internet services, Internet applications and contents.

Internet access and opportunities for using Internet services, Internet applications and contents are today already possible not only in mobile radio networks but also in telephone landline networks, however. These services and applications, and also their contents, can be provided, for example, by network operators associated with the telephone network and also by other operators, such as Internet service providers and mobile Internet service providers.

To date, billing for the use of services, applications and contents provided in telecommunication networks and also for the telephone calls and Internet access via the telecommunication network is generally effected by mapping these services used onto connection time units. An example of this is the premium rate service. Such implementation of the billing for the services used on connection time units has the advantage that billing is possible directly after the service used, that is to say online, as in the case of Hot Billing or Prepaid for telephone calls.

By contrast, for each service provided within or outside a telephone network and not mapped, or not being able to be mapped, onto connection time units, it is necessary to create a separate bill which then needs to be sent to a subscriber associated with the connection set up or to the operator of the service provided or of the application, depending on who will bear the costs for using the service or the application. Examples of this are chargeable Internet services, Internet applications and contents. In particular, such services are not billed directly after the service used, that is to say online, and are also not billed immediately using a Hot Billing or Prepaid billing system available in a telephone network.

If a subscriber in a network now performs a transaction, then, for a single transaction, the subscriber receives a number of separate bills and/or statements online or offline which can be associated with the original transaction only with difficulty. (In this context, transaction is understood to be a series of steps forming a logical unit from the point of view of the subscriber, such as the use of a service, the use of the associated content, which are not mapped onto connection times, and the transmission of the associated information, which is billed for on a time basis.) In this way, for example, Prepaid Cards for the use of services, applications and contents which are not mapped onto connection times are debited only some time after these services, applications and contents are used. As such, the balance of Prepaid Cards can also become negative.

The billing methods customary in telephone networks today cover a maximum of three parties per connection. As can be seen from FIG. 1, for example, these parties may be an operator 3, an end user 2 and a trader 4. For the telephone network 1 used for transmitting data, the operator receives appropriate remuneration in the form of charges. The end user pays these charges to the operator. A third party, namely the trader, has the option, as service provider, of accepting the end user's charges paid to the operator (reverse charging, e.g., telephone numbers starting 0800), of splitting the charges with the end user on the basis of a fixed scheme (e.g., telephone numbers starting 0180) or of charging for his/her service via the telephone network operator (e.g., telephone numbers starting 0900).

In this context, direct price information given in advance is not possible, but rather the price of the service used is determined by the fourth digit of the telephone code called. The previously known billing methods practiced in telephone networks do not permit one or more end users to be billed for services, used within a connection, from a number of operators or traders. Similarly, the billing methods also allow no parties which are not directly involved in the connection to be taken into account.

In multimedia networks, however, many more parties can be involved in billing for a transaction step. Thus, by way of example, it is conceivable for a transaction step to include the use of a service with content and, at the same time, for not only the user but also an operator of the portal, an operator of the service, an operator for the content, an operator for the access network and an operator for the transport network, that is to say a total of six parties, to be involved between whom accounts need to be settled. This can change with each transaction step. The individual statement items on a statement sent at a later date can, therefore, be associated with the respective transaction step only with difficulty.

The present invention is, therefore, directed toward providing a method of billing for the use of a multimedia communications network which permits rapid settlement of accounts between, and with any number of, operators/subscribers and allows the statement items to be associated with a selected transaction step.

### SUMMARY OF THE INVENTION

Accordingly, the inventive method of billing for the use of a, in particular multimedia, communications network on the basis of the associated cost factors for a transaction performed between a number of operators and at least one subscriber takes into account the cost factors generated in such a network by the use of portals, applications, services, contents, basic services, access networks, transport networks, network contents, etc., which can be called network segments.

These services, applications, contents, etc., are made available by various providers who, in addition to the operators of a network in the narrower sense, also can be called “operators”.

The method of billing for the use of multimedia networks makes it possible to bill both the subscriber and the operator of a network, and also other operators involved in the communication, for the use. In this context, at least three operators/subscribers form the parties involved in a shared communication link, set up over the multimedia network.

Billing is performed for each party involved in using the network. In addition, other parties, which appear not as parties involved in the use but rather in the billing, also can be taken into account in the billing. In this context, such a further party can accept all the costs or part of the costs for the communication link set up.

For each party, a respective specific billing model is created in real time. This is used to stipulate a payment direction with the billing parameters relevant to the use for each individual link to a respective one of the other parties, the billing models are collated with one another and then a billing data record is created for each party on the basis of his/her billing model, the billing data record containing the billing parameter values. The amounts to be paid to the other parties and/or the amounts to be paid by the other parties are ascertained using the billing data record.

Creating a billing model for each subscriber, service provider and operator in the network gives a representation of all the crucial payment flows from and to the subscriber and the operator. In this context, a payment flow going to a subscriber or operator can be equated, by way of example, to a credit to his/her account, and a payment flow leaving the subscriber or the operator is comparable to a debit to his/her account.

On the basis of such a billing model, at least one billing data record is then created for each connection to and between the other operators and/or subscribers using the billing parameters relevant to the use, and their values. The billing parameters are parameters describing the type and form of the resultant charges when billing the use. In this context, a distinction is drawn between billing parameters which are dependent on use and billing parameters which are independent of use. The parameters independent of use can be allocated those charges which arise independently of the use of a particular service or application. By way of example, this is the case for an operator who does not calculate the charges on the basis of the time for the use of a service, the volume of data transmitted or the distance of the connection, but rather uses a monthly blanket price covering a particular set of services. Such charging independently of use is also called a “flat rate”. For the billing parameters which are dependent on use, a charge is estimated per transaction, per time unit, per transmitted page or depending on location, for example.

The billing model created and the associated billing data records for each connection to and between the operators and/or subscribers in the network thus can be used to debit charges in real time which are included in the billing both as a result of billing parameters which are dependent on use and those which are independent of use.

Since the billing data record for each connection contains only those billing parameters which arise on the basis of the acceptance of costs by the other operators and/or subscribers, it is possible to make an accurate list of all the costs and credits for the subscriber and of all the costs and credits for the operators and the billing thereof. This can cover the debits and credits not only between a subscriber using a service, for example, and the operator, but also the debits and credits which have been arranged between the operators on the basis of previous contracts.

The billing model and the billing data records also can be used to allocate the charges which have arisen for various services of a provider (convergent billing). Thus, a subscriber in the multimedia network can use both the mobile radio service and an Internet access service from a service operator. Within the context of convergent billing, the subscriber then can be given a quota of free online hours of use if his/her mobile radio bill exceeds a particular limit per month.

In one preferred embodiment, a billing data record type is used to determine those billing data which need to be collected for billing a subscriber or an operator. The billing data include not only the aforementioned billing parameters and values thereof, but also the number of connections to the other operators and/or subscribers, parameters relating to the type of use, and the predetermined tariffs for the individual billing parameters. The latter are normally stipulated by prior contracts between the subscribers and/or operators. If required, the billing parameters selected for a subscriber may differ for the same subscriber on the basis of the parameters relating to the type of use. In this context, possible parameters relating to the type of use are parameters for a call or for packet transmission. To simplify the handling of these parameters relating to the type of use during billing, they are split into “use classes.”

A particular billing data record is respectively determined for a particular time t. As soon as a billing data record changes for successive times t on the basis of a change in the number of operators and/or subscribers involved, in the use class, the billing parameters and/or in the tariffs, all the billing data relating to the prior time interval are combined and a billing data record is created for each subscriber and/or operator.

A billing data record type also can be declared to be invalid by ending the use or one of the connections or by virtue of a prescribed rule for a particular billing parameter, such as that the time interval can only be a maximum of 10 minutes or the billing record type is valid only until the end of the transaction, etc.

The aforementioned rules can be defined both individually and in combination. In this context, it is possible to administer the criteria for the end of the validity of a billing data record type. If an indication of time is used in a rule, then this relates to a time of day which is synchronized in the operator systems involved.

As soon as a billing data record type is declared to be invalid, a billing data record is created for the connection to a particular operator and/or subscriber. Provided that the subscriber continues to use the service, a new billing data record type is then determined. As such, new changed billing data can be selected in the new billing data record type, and the changed circumstances within the communication link can be taken into account. Consequently, one or more billing data record types can exist for one or more billing data records, in particular for billing using billing parameters which are dependent on use.

The billing data record types having a one-to-one association with each billable subscriber and/or operator for each connection and for all the times t in the interval in which the connections exist preferably include a billing structure and associated billing semantics derived from the billing model for all the operators and/or subscribers involved in the connections at the time t.

The one-to-one nature of the billing data record types can be dependent on additional parameters, such as the location at which the subscriber and/or operator to be billed is situated at the time t. A billing data record type thus can be created by including a multiplicity of billing data, as compared with billing in today's telephone networks. In this case, the billing structure and the billing semantics for billing are identical both for debits and for credits to the account of a subscriber and/or operator.

Owing to the creation of a billing model with the associated billing data records for each subscriber and/or operator in real time, taking into account the acceptance of costs by other operators, Prepaid Cards can be debited immediately, and there is no need for subsequent issuing o f bills. However, the inventive method also may be used for any type of billing, such as Prepaid, Postpaid through a bank, by credit, etc. The billing time at which the bill is sent to the subscriber and/or operator also can be determined on an individual basis. Thus, by way of example, the bill can be sent immediately after the service has been used or on every 30th day of a month.

The predetermined tariffs for the billing parameters need to have a one-to-one association between and with the other operators and/or subscribers on the basis of the applicable tariffs at the time t for the subscribers and/or operators to be billed. However, the tariffs can be modified for each billing parameter between the times t, so that one tariff or a number of tariffs may apply for each billing parameter.

For each tariff associated with a billing parameter, it is possible to determine whether it is also included directly in the billing for the use which has taken place with the associated connections set up to other operators and/or subscribers or whether it is covered in separate billing; namely, indirect billing. Thus, by way of example, the advertising of a sponsor, who may appear in the network both as an operator and as an independent third party and who is allocated a separate billing structure, also will be included directly in the billing for the use of the service, whereas bonus programs, such as Web Miles, can result in separate bills which can be included in the billing for a service at a later time.

The billing model which was created at the start of the connections set up and which is formed for each subscriber and/or operator using the relevant billing data is static, given unchanged billing data, until the connections are ended. However, a number of versions of a billing model may exist. Thus, all billing needs to be allocated a version of the billing model on a one-to-one basis, with each version covering billing structures, tariff structures and links between these structures for all possible operators and/or subscribers involved who are connected to a particular subscriber and/or operator or have connections among themselves.

Thus, the billing model reflects the contracts and agreements between the operators and/or the subscribers at the time of billing. By way of example, a new version of a billing model needs to be created when a link is added between the subscriber and another operator. This version of a billing model can be stored centrally or on a distributed basis within the multimedia network, like the previous versions. The continuous fresh matching of the billing model to the new circumstances within the multimedia network thus guarantees up-to-date and reliable billing.

When billing using billing parameters which are independent of use, each subscriber and/or operator to be billed has exactly one billing data record type for a billing data record. This billing data record type is associated with the time interval for which the billing is to take place, with one-off payments, such as a basic charge to the network operator, having exactly one time interval with the same starting and ending times. Once the ending time of the time interval is reached, the billing data record type becomes invalid and a billing data record is created. In the case of regular payments, such as in the case of the flat rate, a new billing data record type is produced, possibly with the same content.

It should be noted that Prepaid Cards can be debited only when access to the Prepaid Card is possible, such as when a fresh communication link is set up.

To be able to create billing models and billing data records which are specific to subscribers and operators, the billing data record types contain at least one identification character string in their structure, such as a user identification (e.g., in the form of a telephone number or IP address unique throughout the world) for clearly identifying the parties throughout the world.

One way of producing a billing data record type is to use a vector storing not parameters specific to subscribers and operators, but rather pointers to subsidiary data record types for the billing specific to the subscribers and operators. In this way, the subsidiary data record types used can be billing data record types which already have been standardized, such as Call Detail Record (CDR). Each subsidiary data record type is valid until a use class, a billing parameter or a tariff changes within the subsidiary data record type, or the connections are ended, or a rule prescribed for the billing parameters applies as an option. If an indication of time is used in a rule, this refers to a time of day synchronized in the operator systems involved. The billing data record type becomes invalid as soon as a subsidiary data record type becomes invalid. The criteria crucial for the end of the validity of a subsidiary data record type also can be administered.

Permanently defined (static) billing data record types need to be able to be prescribed for all or individual subscribers/operators.

In one preferred embodiment, for each connection to another operator and/or subscriber, a use data record containing use data is created, with the use data being made up of dimensions for the respective billing parameters. A use data record type determines which use data are collected using the billing data record types for all the communication links to and between other operators and/or subscribers. The dimension expresses a measure of the size of the respective billing parameter. Thus, by way of example, for the billing parameter “connection time in seconds,” the dimension 50 can be equated to a connection time of 50 seconds. For the billing parameter “data transfer rate kbits,” the dimension 2500 signifies a transfer rate of 2500 kbits. The use data record type containing all the current billing parameters with associated use data for all the subscribers and operators involved in the communication links determines the selection of the use data to be collected using the use-dependent billing data record types for all the subscribers and/or operators involved in the communication links.

The use data record type, too, can be produced using a vector containing, for each party, at least one pointer to the billing data record types for the parties. If, by way of example, a portal operator bills a subscriber using a service for this service by click, but bills the service provider by use, the use data record type for the portal operator contains two billing parameters: by click (service) and by service use.

To prevent redundancy in the data collection, as is the case, for example, when a service is repeatedly billed by use, another implementation option may be that of combining the use data record type all billing data record types for all the parties to form a new use data record type. Such combination eliminates duplicate fields. Implementation is effected in a similar way to the implementation of the billing data record types.

The use data record types are valid for as long as the associated billing data record types are valid. As soon as a use data record type becomes invalid, the associated use data record is created and concluded.

Fixed (static) use data record types for collecting use data can be prescribed for one or all parties. The parties can be replaced with variables in the use data record types.

Additional features and advantages of the present invention are described in, and will be apparent from, the following Detailed Description of the Invention and the Figures.

### BRIEF DESCRIPTION OF THE FIGURES

FIG. 1 shows a schematic illustration of a telephone network with three parties based on the prior art.

FIG. 2 shows a schematic illustration of a multimedia network with a multiplicity of parties based on the present invention.

FIG. 3 shows an illustration of a billing model based on a first embodiment of the present invention.

FIG. 4 shows an illustration of a billing model based on a second embodiment of the present invention.

FIG. 5 shows an illustration of another billing model based on the second embodiment.

### DETAILED DESCRIPTION OF THE INVENTION

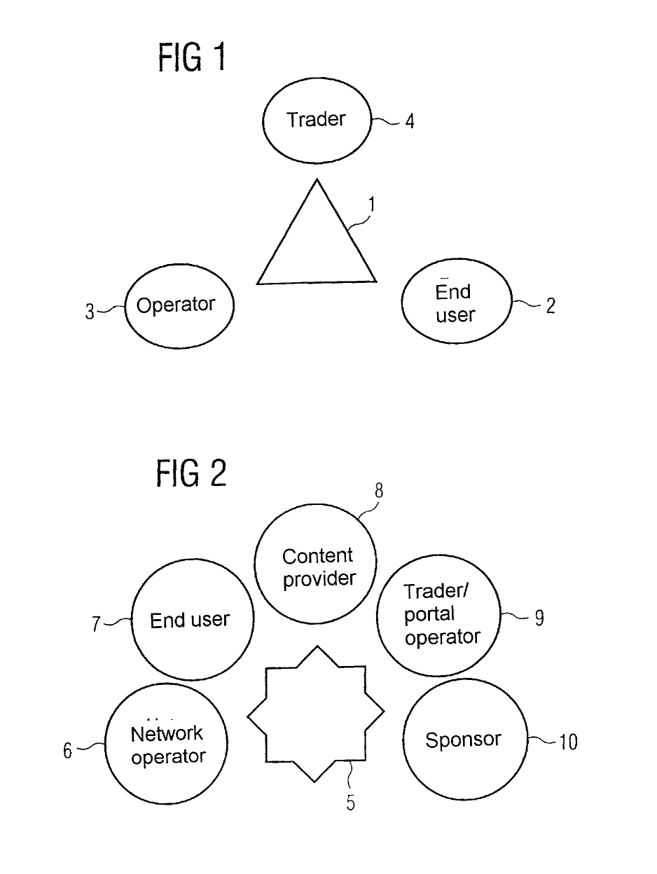

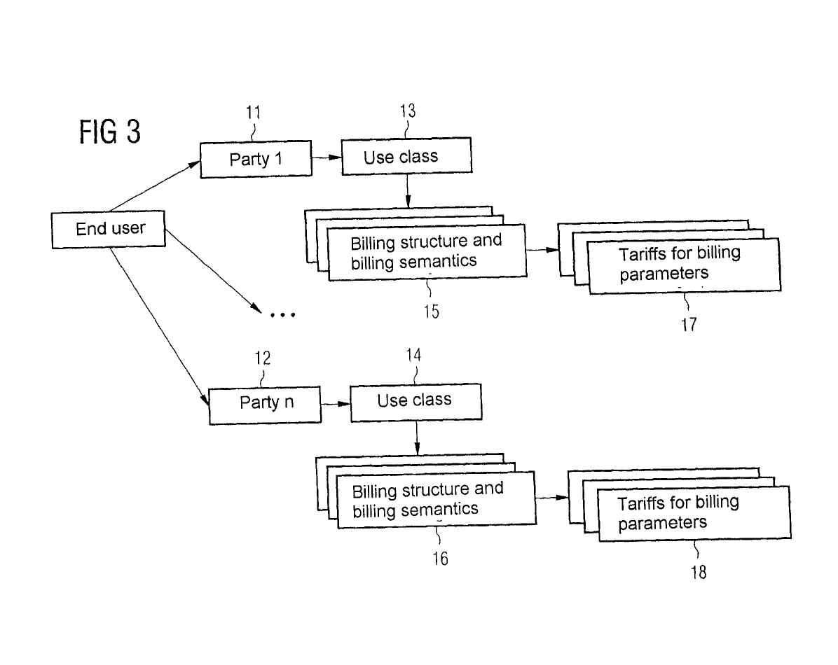

FIG. 1 shows a schematic illustration of a telephone network 1 with three parties; namely, an end user 2, an operator 3 and a trader 4. By contrast, FIG. 2 shows a multimedia network in which more than three parties are involved in billing. On a multimedia network 5, by way of example, a network operator 6, an end user 7, a content provider 8, a trader/portal operator 9 and a sponsor 10 are involved in a communication link. Thus, a number of operators are active in the multimedia network.

It is conceivable for the end user 7, when using a service, to be provided with the content by the content provider 8, to be provided with the portal by the portal operator 9, and for data transmission to be carried out using the network operator 6. The resultant costs for the individual services are billed to the end user 7 or to other operators and/or subscribers, who also may be sponsors. In this context, it should be noted that each operator pursues a separate billing structure reflected by a debit or a credit to the account of the respective operator and/or subscriber on the statement for the use.

FIG. 3 shows a billing model for an end user (subscriber) connected to the parties 1-n.

The billing model is associated with the end user to be billed. The end user is connected to the parties 1-n who, by way of example, are operators of services and networks within the multimedia network. In this case, the structure of the billing data record type associated with the billing model contains a user identification for clear identification of the parties involved 11, 12. According to the specific party, the billing data record type contains various use classes 13, 14 into which the respective type of use can be classified using the parameters for the type of use. Thus, by way of example, for an operator of the network, it is conceivable for the use of the network to be subdivided into the use classes of call and packet transmission.

According to the specific use class, there is a split into various billing structures with associated billing semantics 15, 16 on the basis of the respectively valid billing structure for the associated party 11, 12 with the selected use class 13, 14. The billing data included in the billing data record type relate, among other things, to the billing parameters, their value, their dimension and the agreed tariffs 17, 18 for the billing parameters.

The billing parameters are subdivided into billing parameters which are dependent on use and those which are independent of use, as listed by way of example in the table below.

Billing parameters

| Dependent on use | Independent of use |
|---|---|
| by use | a) at regular intervals |
| by click | |
| by transaction | flat rate (constant rate) |
| by transfer rate (volume, in bits) | rate dependent on policies (security, |
| | quality of service etc.) |
| by packet (volume) | |
| for the content (value) | rate dependent on the selected services |
| by complete download | |
| by stream | rate dependent on the |
| by page | selected contents |
| by minute | basic charge |
| location dependent | |
| time dependent | |
| policy related (security, quality | |
| of service) | |
| | b) one-off |
| | for the access |
| | for the cleardown |

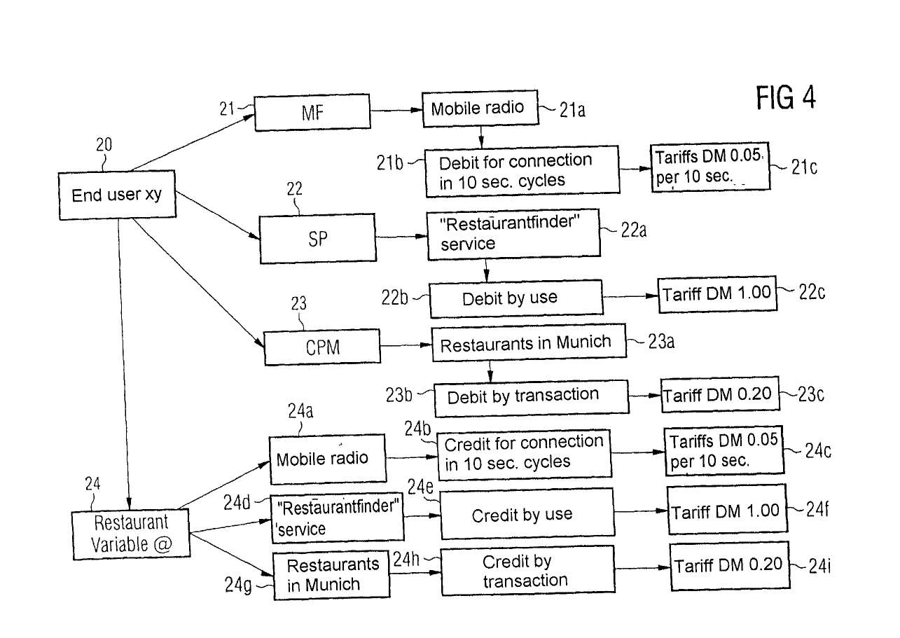

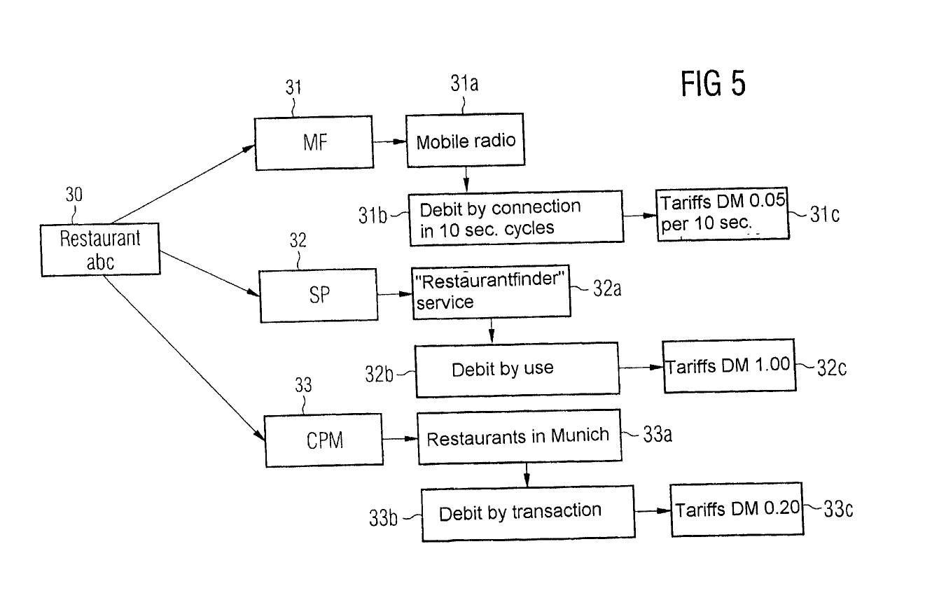

FIGS. 4 and 5 show billing models for an end user (subscriber) and a restaurant (operator) based on a second embodiment of the present invention.

First, a few basic assumptions are indicated for the inventive method of billing an involved party:

The method itself is based on the mechanisms used for database transactions, such as start of transaction, resetting of transaction, provisional end of a transaction and end of transaction. It uses master and slave processes. The creation of billing data record types, the creation of a use data record type and the collection of associated use data, the creation of party-specific billing data records, etc., can be combined into one database transaction in each case. These database transactions can be performed distributed within the network.

One of the basic assumptions for the method of billing an involved party is that the following files can be accessed in this context: the use data record type for the connections, the use data collected therefor and also the billing data record type for the party to be billed. In this context, a preprocessor optionally can be used to match the collected use data to the billing data record type for the party to be billed.

For producing a billing data record type, the following options may be available:

At the start of a communication link between the individual parties and the end user, billing data record types can be produced for solutions based on the Prepaid Card and the Hot Billing process and, during the existing connections, new billing data record types can be respectively produced at the time at which the current billing data record types become invalid, the existing connection and billing data record type being synchronized with one another.

The billing data record types can be produced regardless of the time of the existing connections. This is possible both during and after the use of a service. In this context, the existing connections and the billing data record types are not synchronized with one another.

Billing data record types can be produced in sync with existing connections and also out of sync with existing connections on the basis of the prescribed rules which can be allocated to a billing parameter, for example.

For producing the use data, the following options are conceivable:

If the existing connections and the billing data record types are synchronized with one another, then it is necessary to collect only those billing data which have been determined by the billing data record types for all the parties involved. This type of production of use data is the best solution for the Prepaid Card and Hot Billing payment types.

If the existing connections and the billing data record types are not synchronized, then it is necessary to collect all the conceivable use data which are required by the parties involved and have been produced from the billing models of the parties involved. In this case, a fixed, that is to say stable, use data record type is needed.

The billing data are collected upon static collection of use data regardless of any specific use and regardless of the parties involved. In this case, a fixed use data record type is needed.

The use data are respectively collected in line with one of the aforementioned variants on the basis of prescribed rules, as is necessary, for example, in order to incorporate existing billing methods. In this case, a fixed use data record type is needed for the collection of billing data.

Alternatively, a variable in the use data record types can be replaced with the actual date at the time of use. In principle, a variable also may be connected to a rule only at the time of use, as is the case, for example, when a specific restaurant has been found in a restaurant search transaction and a connection is set up to the restaurant.

In principle, there are no direct dependencies between the billing methods for various parties involved.

Various types of billing can be taken into account in a billing method based on the present invention. Thus, by way of example, in the “All inclusive” billing type, a combination of all the services in the existing connection can be provided to the end user by an operator (provider) at a special tariff called “All inclusive.” Hence, the billing model for the end user contains only one billing party, one use class, one billing parameter and one or more associated tariffs.

In the “All in one” billing type, all the parties involved in the existing connections are taken into account in the end user's billing model together with their use classes, billing parameters and tariffs.

A basic prerequisite for the security of the billing method based on the present invention is secure key distribution; certification of the parties involved is air option. Details depend on the security level chosen, the security functions used, security mechanisms and security algorithms.

The way in which the inventive method proceeds will now be described in more detail using the exemplary embodiment shown in FIGS. 4 and 5.

A service provider 22 provides a “Restaurantfinder” 22a as a service. The associated content 23a is provided by a content provider 23 for the city of Munich. The service can be used from any terminal, in particular any mobile terminal, from any location using any access network. An end user 20 (subscriber) uses the service in Munich via the operator of the mobile radio network 21 with the “mobile radio” service 21a. The selected restaurant 24 bears all of the costs associated with the use.

The method now includes three processes taking place independently of one another: the modeling process, the use data collection process (charging) and the party-specific billing process (billing/payment).

Each of these processes is controlled by a master process taking place on an explicitly associated server. The master process can either take place continuously (in the background) or else can be started specifically for a particular time interval/event.

The server for the master process for the modeling phase is prescribed by the authority undertaking the billing. The server for the master process for the use data collection phase is stipulated on the basis of specific end users. The address unique throughout the world is stored in the billing model for the end user. The server for the master process for the party-specific billing is stipulated according to the specific party. The address unique throughout the world is stored in the billing model for the party to be billed; namely the restaurant 24.

Each master process can, optionally, start slave processes with which individual process steps are started. The master processes are started independently of one another. Communication and synchronization between the processes, that is to say between the master processes and between master and slave processes, takes place via trigger devices.

The task of the modeling process is to create the billing models for each party to be billed. The billing model is stored on a database or in a file. The address of the associated database server is available throughout the world, and this address can be used to access the database server throughout the world.

The result of the modeling process is the associated billing models, as shown for the end user in FIG. 4, and for a specific restaurant abc with the reference 30 in FIG. 5.

The result of the modeling process is a prerequisite for the use data collection process and for the party-specific billing processes. The use data collection process takes place when the existing connections start billing for specific use. The collection of use data presupposes a valid use data record type.

The valid use data record type can change repeatedly for the existing connections in the course of the individual time periods.

The result of the use data collection process is shown under the billing data record type for the end user as follows:

| | | | | | | | Res- | |
|---|---|---|---|---|---|---|---|---|
| | | Poin- | | Poin- | | Poin- | taurant | Pointer |
| | | ter | | ter | CPM | ter | Var- | Res- |
| User Id | MF-Id | MF | Sp-Id | SP | -Id | CPM | iable | taurant |

| | |
|---|---|
| MF: Length of connection | Semantics: 0.05 DM/10 sec.debit |
| SP: Number of uses | Semantics: 1.00 DM/Use debit |
| CPM: Number of transactions | Semantics: 0.20 DM/transaction debit |
| Restaurant: Length of connection | Semantics: 0.05 DM/sec. credit |
| Restaurant: Number of uses | Semantics: 1.00 DM/use credit |
| Restaurant: Number of transactions | Semantics: 0.20 DM/Transaction |
| | credit |

The following applies for the restaurant's billing data record type:

| Res- | | | | Pointer | | Pointer |
|---|---|---|---|---|---|---|
| taurant Id | MF-Id | Pointer-MF | SP-Id | SP | CPM-Id | CPM |

| | |
|---|---|
| MF: Length of connection | Semantics: 0.05 DM/10 sec. |
| | debit |
| SP: Number of uses | Semantics: 1.00 DM/use |
| | debit |
| CPM: Number of transactions | Semantics: 0.20 DM/ |
| | transaction debit |

From these billing parameters shown in the billing data record types, the optimized use data record type for the existing connections is created as follows:

| | | | | | | | Res- |
|---|---|---|---|---|---|---|---|
| | | Pointer | | Pointer | | Pointer | taurant |
| UserId | MF-Id | MF | SP-Id | SP | CPM-Id | CPM | variable |

MF: Length of connection
SP: Number of uses
CPM: Number of transactions

Next, an accepted use data record is created, that is to say taking into account the dimension measured:

| | | | | | | Poin- | Res- |
|---|---|---|---|---|---|---|---|
| UserId | MF-Id | Pointer- | SP-Id | Pointer- | CPM-Id | ter- | taurant |
| “xy” | ”MF” | MF | “SP” | SP | “CPM” | CPM | “abc” |

MF: Length of connection 7.6.00
from 10.00 to 10.10.
SP: Number of uses = 1
CPM: Number of transactions = 3

Each use data record concluded is used as an input for the party-specific billing processes. The type of billing (Prepaid, Postpaid through a bank, by credit etc.), the interval for the use data used in the billing, such as immediate billing, the use data for the last 30 days, etc., and the time of billing (immediately or on the 30th day of a month) have been stipulated for each party to be billed. In this context, the course of the party-specific billing processes includes three steps:

First, the collected use data, if available, for one or more existing connections in which the respective party is involved are filtered onto the party-specific billing data record types. Optionally, a preprocessor may be used for this step. The result of this step is a set of pairs, including billing data record types and associated use data.

In a second step, a bill is issued, in which payments/credits are allocated to each billing data record type and a sum total is formed. For each billing data record type and for each party involved, the use data, if they are available, relating to the individual billing parameters and the associated tariff information are used to ascertain a payment or a credit. The sum total for the entire period of the billing is likewise ascertained.

As a last step, the account of the party to be billed is debited or credited in accordance with the chosen billing type.

The result of the billing process for the end user is thus:

| | |
|---|---|
| Connection via network operator | DM 3.00 (debit) |
| 1 use of Restaurant finder from Service | DM 1.00 (debit) |
| Provider SP | |
| 3 transactions from Content Provider | DM 0.60 (debit) |
| CPM | |
| Costs accepted by restaurant abc | 4.60 (credit) IDM |
| Sum total | DM 0.00 |

The result of the billing process for the restaurant is then:

In this example, the end user is not debited, whereas the restaurant accepts all of the costs for use of the service of a Restaurantfinder.

| | |
|---|---|
| Connection fee for network operator | DM 3.00 (debit) |
| MF: 60 cycles of 10 sec. | |
| 1 use of Restaurant finder from Service | DM 1.00 (debit) |
| Provider SP | |
| 3 transactions from Content Provider | 0.60 (debit) IDM |
| CPM | |

In conclusion, it will be stated that the security of the individual processes is guaranteed by the respective master process. These include, in particular, the authentication of slave processes and servers, the access control for ˜e billing model, the use data and the billing data, and the confidential and integral transmission of information; in particular, of party-specific data.

Although the present invention has been described with reference to specific embodiments, those of skill in the art will recognize that changes may be made thereto without departing from the spirit and scope of the invention as set forth in the hereafter appended claims.

1. A method of billing for use of a multimedia communications network based on associated cost factors for a transaction performed between a plurality of operators and a subscriber using a respective access device for accessing the network, the method comprising the steps of:
creating, transmitting and processing a billing data record in the communications network; and
using the respective access device, by at least one of an operator/subscriber involved in the transaction and a further operator/subscriber, after the transaction, to settle accounts with a plurality of operators/subscribers in real time using the billing data record.

2. A method of billing for use of a multimedia communications network as claimed in claim 1, the method further comprising the steps of:
creating a respective specific billing model in real time for each operator/subscriber for purposes of settling accounts with the plurality of operators/subscribers;
using the respective specific billing model to stipulate a payment direction and billing parameters relevant to the use for each individual connection to a respective one of the plurality of operators/subscribers;
collating the billing models with one another in a verification procedure;
using a respective billing model, for each operator/subscriber, to create a billing data record containing billing parameter values for specific connections; and
ascertaining amounts to be paid between each operator/subscriber and the plurality of operators/subscribers using the billing data record.

3. A method of billing for use of a multimedia communications network as claimed in claim 2, the method further comprising the step of creating at least one billing data record type, for each billing data record, having a billing structure and billing semantics, which determines a scope of billing data collected for billing.

4. A method of billing for use of a multimedia communications network as claimed in claim 3, wherein the billing data are made up of the billing parameters, the billing parameter values, predetermined tariffs for the billing parameters, the number of connections set up to the plurality of operators/subscribers and parameters relating to the type of use.

5. A method of billing for use of a multimedia communications network as claimed in claim 3, the method further comprising the steps of:
ending the billing data record type when there is a change in one of the billing parameters, the number of connections, the parameters relating to the type of use, and the predetermined tariffs for the billing parameters;
creating a new billing data record; and
starting a new billing data record type.

6. A method of billing for use of a multimedia communications network as claimed in claim 5, wherein a particular billing data record type is valid for a prescribed time interval.

7. A method of billing for use of a multimedia communications network as claimed in claim 2, the method further comprising the step of billing the use based on a predetermined time for each relevant billing parameter.

8. A method of billing for use of a multimedia communications network as claimed in claim 3, wherein the billing data record type contains an operator/subscriber identification character string.

9. A method of billing for use of a multimedia communications network as claimed in claim 2, the method further comprising the step of creating at least one use data record containing use data, for purposes of billing based on scope of use, for each connection set up to the plurality of operators/subscribers, the use data being made up of values for the respective billing parameter.

10. A method of billing for use of a multimedia communications network as claimed in claim 9, the method further comprising the step of creating at least one use data record type, for each use data record, which uses the billing data record types for all connections to and between other operators/subscribers to determine which use data are collected.

11. A method of billing for use of a multimedia communications network as claimed in claim 10, wherein the use data record type is valid for as long as the associated billing data record type.
